(19) United States
(12) Patent Application Publication
(10) Pub. No.: US 2025/0237751 A1
(43) Pub. Date: Jul. 24, 2025

(54) SELF-ADAPTIVE TRIGGER ACQUISITION METHOD OF AIRBORNE BATHYMETRIC SURVEY LASER RADAR

(71) Applicant: GUILIN UNIVERSITY OF TECHNOLOGY, GUILIN (CN)

(72) Inventors: Guoqing ZHOU, GUILIN (CN); Kaiyun BAO, GUILIN (CN); Xiang ZHOU, GUILIN (CN)

(73) Assignee: GUILIN UNIVERSITY OF TECHNOLOGY, GUILIN (CN)

(21) Appl. No.: 18/988,783

(22) Filed: Dec. 19, 2024

(30) Foreign Application Priority Data
Jan. 23, 2024 (CN) 202410094507.1

(51) Int. Cl. G01S 7/4913; G01S 7/48; G01S 7/481; G01S 17/32; G01S 17/88

(52) U.S. Cl. CPC G01S 7/4913; G01S 7/4802; G01S 7/4817; G01S 17/32; G01S 17/88

(57) ABSTRACT

The present disclosure discloses a self-adaptive trigger acquisition method of an airborne bathymetric survey laser radar, including calculating a distance between laser light and a water surface and a height between the laser radar and the water surface, and obtaining delay time before sampling; converting water surface and water bottom echo numerical values into corresponding voltage amplitude values, then calculating corresponding electric signals, and calculating light energy by a photoelectric conversion relation; determining a water body attenuation coefficient by water surface and water bottom light energy losses; and determining a maximum water depth by the solved water body attenuation coefficient, then solving sampling time, and finally realizing self-adaptive trigger acquisition. The present disclosure mainly solves the technical problem that the conventional acquisition method cannot realize self-adaptive acquisition of water bottom topographic data in different water areas on laser radar devices with different scanning angles.

### CROSS-REFERENCE TO RELATED APPLICATIONS

This application claims the priority benefit of China application no. 202410094507.1 filed on Jan. 23, 2024. The entirety of the above-mentioned patent application is hereby incorporated by reference herein and made a part of this specification.

### BACKGROUND

### Technical Field

The present disclosure relates to the technical field of laser detection, and particularly to a self-adaptive trigger acquisition method of an airborne bathymetric survey laser radar.

### Description of Related Art

At present, a traditional laser radar generates a huge amount of echo signal data in a short time, and although full waveform data may be acquired, the beginning and ending of each waveform acquisition are not accurately located. In addition, when the laser radar detects a water depth of an unknown sea area, the uncertainty of water quality will have a certain impact on bathymetric survey. In this regard, the present disclosure provides a self-adaptive trigger acquisition method of an airborne bathymetric survey laser radar, which is used for designing the airborne bathymetric survey laser radar to accurately acquire water bottom topographic data under seawater with any water quality at any height.

An airborne bathymetric survey laser radar acquires a huge amount of water bottom waveform data at different heights. In the case of different water areas and different heights, the energy and frequency of the laser radar need to be adjusted accordingly. Therefore, a method capable of realizing self-adaptive acquisition and storage space reduction is needed. The patent number CN115620797A titled an AFIFO-based chip internal signal waveform acquisition and storage method and device from Xiaojun Liu, et al. of Microelectronic Technology (Wuhan) Co. Ltd. provides a waveform acquisition and storage method, which triggers acquisition conditions by default, and this triggering method is too simple to self-adaptively trigger acquisition according to conditions. In addition, it takes up a lot of storage space to control whether subsequent internal signal data will continue to be written after the AFIFO is full by a coverage enable indicator signal.

The airborne bathymetric survey laser radar has a large amount of data transmission, so that the reduction of storage space of echo data is more conductive to saving a lot of storage space. The patent number CN113608195A titled a laser radar full-waveform data decomposition bathymetric survey method and device, and an electronic device from Yuan Yue, et al. of China University of Geosciences (Wuhan) provides a laser radar full-waveform data decomposition bathymetric survey method, which acquires full-waveform data of a water area detected and studied, and superimposes original echo data. However, the decomposition of the full waveform data and the superposition of the echo data result in a huge amount of data, thus taking up a lot of storage space, and leading to excessively large workload.

Accurate echo signal sampling time is beneficial for reducing the acquisition workload and the storage space. The patent number CN116338628A titled a laser radar bathymetric survey method and device based on a learning architecture, and an electronic device from Yifu Chen, et al. of China University of Geosciences (Wuhan) refers to making a water surface echo signal position and a water bottom echo signal position accurate, thus acquiring first high-precision full-waveform laser radar data. However, the sampling time is not accurate in this method, which causes excessively large workload for the full-waveform acquisition of the laser radar and excessively high time complexity. Moreover, a lot of storage space is occupied by the acquired waveform data.

The airborne bathymetric survey laser radar has a complicated propagation process in turbid or weak-substrate-reflectivity water, thus affecting survey precision. The patent number CN116359939A titled an intensity data extraction method and system for an airborne laser radar bathymetric survey system from Xue Ji, et al. of Jilin University refers to feature extraction of water surface reflection waveform and full-waveform data. However, this patent does not discuss how to design an accurate full-waveform data acquisition method, and when the water area has high turbidity, a penetration ability of blue-green laser light is seriously attenuated, so that the survey precision is limited.

Full-waveform signal acquisition takes up a lot of storage space and increases the time complexity, thus being not conducive to quick storage. The patent number CN116973877A titled a millimeter wave radar deformation measurement method and system, and a measurement truth value calibration method from Wei Huang, et al. of Nanjing Chuhang Technology Co., Ltd. refers to receiving a corresponding echo signal after a radar transmission signal is sent out. At this time, the full-waveform signal data are received, resulting in a lot of data redundancy, which increases the time complexity of subsequent analog-to-digital conversion to obtain ADC data.

The above patents cannot adjust a trigger acquisition moment according to different heights and different laser radar devices, so that the quality of acquired data cannot be guaranteed. Moreover, it is impossible to change the sampling time according to different water qualities only according to a single survey standard such as frequency and energy of the laser radar, thus generating a huge amount of invalid data and occupying a lot of storage space. Finally, self-adaptive echo data acquisition cannot be realized in different water areas. In order to solve the above problems, the present disclosure provides a self-adaptive trigger acquisition method of an airborne bathymetric survey laser radar.

### SUMMARY

The present disclosure aims to provide a self-adaptive trigger acquisition method of an airborne bathymetric survey laser radar, which can effectively and accurately acquire delay time before sampling and sampling time, thus saving more data space. In order to provide an effective guarantee for acquiring accurate waveform data, the airborne bathymetric survey laser radar of the present disclosure employs an elliptical scanning mode.

The above technical objective of the present disclosure can be achieved by the following technical solution: a self-adaptive trigger acquisition method of an airborne bathymetric survey laser radar comprises the following steps:
step 1: calculating a distance between laser light and a water surface through a main wave signal and a water surface echo signal, calculating a height between the laser radar and the water surface by a scanning angle of an elliptical scanning mode and a trigonometric function formula, calculating time when a vertical component of the laser light reaches the water surface by the height, and setting delay time before sampling to be a sum of time of the main wave signal and the time when the vertical component of the laser light reaches the water surface;
wherein, the distance ρ between the laser light and the water surface is expressed by formula (1):

$$ρ = \frac{1}{2} \times t \times c \qquad ( 1 )$$

wherein, t is time when the laser light reaches the water surface, and according to a water surface echo waveform, c is a propagation speed of light in air;
a reflecting mirror is evenly rotated, and a change of a scanning angle θ is similar to a cosine curve; when the reflecting mirror is rotated to satisfy that ϕ=0° or 180°, the scanning angle reaches a maximum degree of θₘₐₓ=15°; and when the reflecting mirror is rotated to satisfy that ϕ=90° or 270°, the scanning angle θ reaches a minimum degree of θₘᵢₙ=10° 35′29″,
the height H between the laser radar and the water surface is expressed by formula (2):

$$H = ρ cos θ \qquad ( 2 )$$

the time t₁ when the vertical component of the laser light reaches the water surface is expressed by formula (3):

$${t}_{1} = 2 H / c \qquad ( 3 )$$

the delay time t₃ before sampling is expressed by formula (4):

$${t}_{3} = {t}_{1} + {t}_{2} \qquad ( 4 )$$

wherein, t₂ is the time of the main wave signal;
step 2: converting water surface and water bottom echo numerical values into corresponding analog voltage amplitude values through a formula, obtaining corresponding electric signal values by the voltage amplitude values and PMT gains, and then obtaining water surface and water bottom light energy through a photoelectric conversion relation;
wherein, a conversion relation between the echo numerical value and the analog voltage amplitude value is expressed by formula (5):

$${V}_{Ana} = ( Data \times {V}_{p p} ) \div {2}^{a - 1} \qquad ( 5 )$$

wherein, V_{Ana} is the analog voltage amplitude value of the echo signal, Data is a value after AD conversion, Vₚₚ is a full-amplitude voltage of a chip, with a value of 1.7 V, a is a resolution, the voltage amplitude value is calculated through formula (5), and the calculated voltage value is obtained after PMT amplification;
step 3: determining water quality by comparing water surface and water bottom light energy losses, and then solving a water body attenuation coefficient, according to the following calculation formula (10)

$$K = - \frac{1}{d} ln \frac{E ( d )}{E ( 0 )} \qquad ( 10 )$$

wherein, K is the water body attenuation coefficient, d is a depth, E(d) is light energy at the depth d, and E(0) is water surface light energy; and
step 4: determining a maximum water depth by the solved water body attenuation coefficient, and then solving sampling time,
wherein, water body absorption and scattering effects affect a maximum survey depth of an airborne bathymetric survey laser radar system, the water body absorption and scattering effects are usually expressed by the water body attenuation coefficient K, and the maximum survey depth and a water quality parameter are expressed with the water attenuation coefficient K by formula (11):

$${D}_{m} = \frac{ln ( {p}^{*} / {P}_{b} )}{2 K} \qquad ( 11 )$$

wherein, p* is a relevant parameter of the airborne bathymetric survey laser radar, P_{b} is a parameter of background light power, and K is the water body attenuation coefficient, and finally, the sampling time is expressed by formula (12)

$$T = 2 ( \frac{ρ}{c} + \frac{4 c {D}_{m}}{3} ) \qquad ( 12 )$$

wherein, ρ is the distance between the laser light and the water surface, c is a speed of light, and Dₘ is the maximum survey depth.

The present disclosure has the beneficial effects that: firstly, by accurately acquiring the sampling time, the storage space required for acquisition is greatly reduced; and secondly, the present disclosure provides a laser radar self-adaptive trigger acquisition model, which may self-adaptively adjust the sampling time according to sea areas with different water qualities, and self-adaptively adjust the delay time before sampling according to different heights of the airborne bathymetric survey laser radar, thus facilitating bathymetric survey.

### BRIEF DESCRIPTION OF THE DRAWINGS

FIG. 1 is a flow chart of a self-adaptive trigger acquisition method of an airborne bathymetric survey laser radar of the present disclosure;

FIG. 2 is a schematic diagram of elliptical scanning of the airborne bathymetric survey laser radar;

FIG. 3 is a schematic diagram of bathymetric survey of the airborne bathymetric survey laser radar;

FIG. 4 is a schematic diagram of a change curve of a scanning angle θ of the airborne bathymetric survey laser radar; and

FIG. 5 is a schematic diagram of a characteristic curve of a photomultiplier tube.

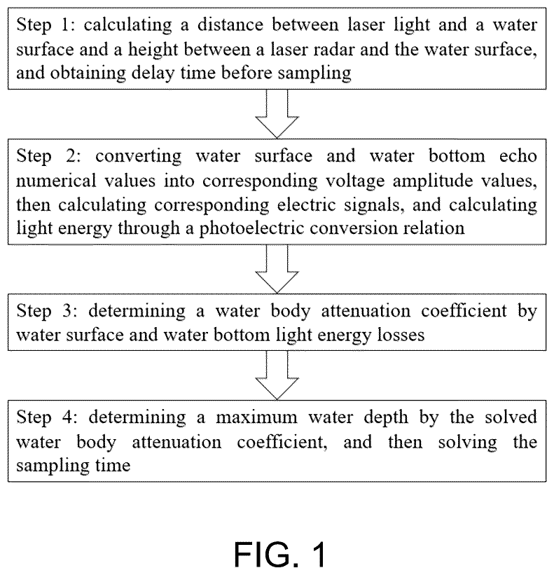

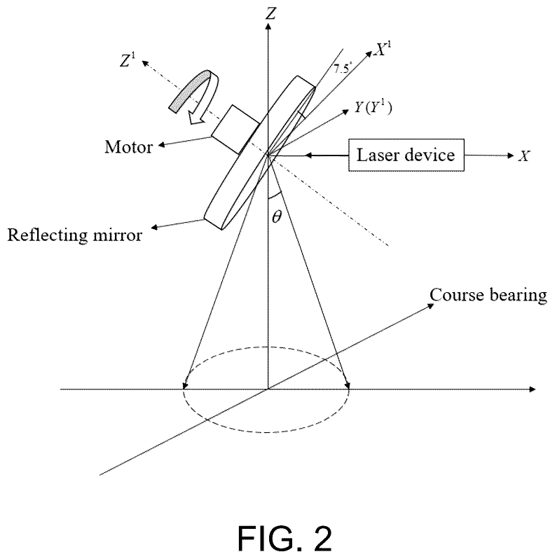

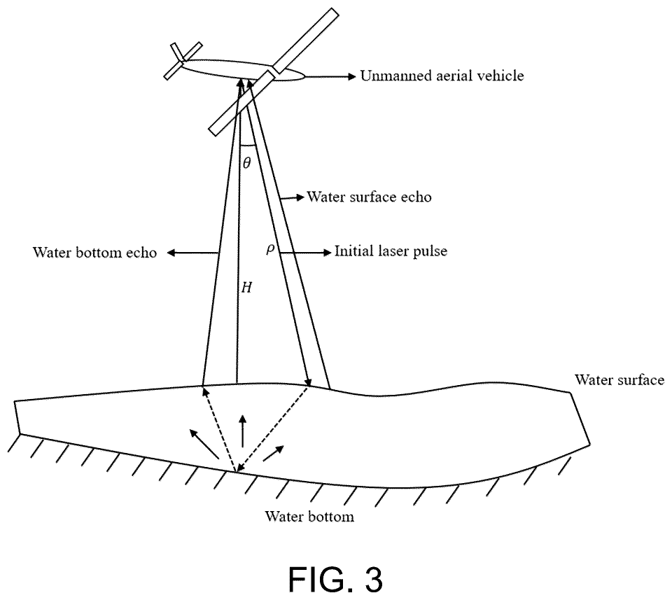

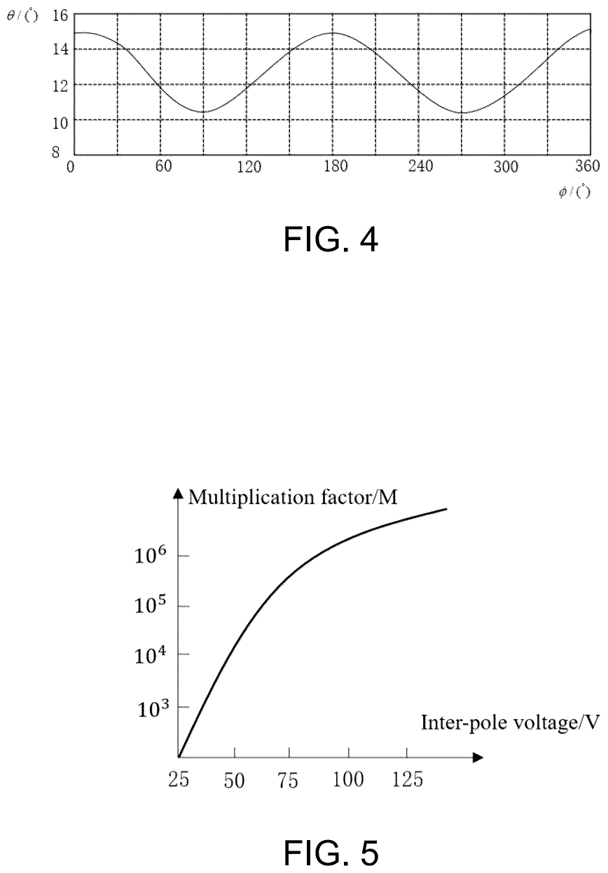

### DESCRIPTION OF THE EMBODIMENTS

In step 1, a distance between laser light and a water surface and a height between a laser radar and the water surface are calculated, and delay time before sampling is obtained.

The distance ρ between the laser light and the water surface is expressed by formula (1):

$$ρ = \frac{1}{2} \times t \times c \qquad ( 1 )$$

wherein, t is time when the laser light reaches the water surface, and according to a water surface echo waveform, C is a propagation speed of light in air.

A reflecting mirror is evenly rotated, and a change of a scanning angle θ is similar to a cosine curve; when the reflecting mirror is rotated to satisfy that ϕ=0° or 180°, the scanning angle reaches a maximum degree of θₘₐₓ=150; and when the reflecting mirror is rotated to satisfy that ϕ=90° or 270°, the scanning angle θ reaches a minimum degree of θₘᵢₙ=10°35′29″.

The height H between the laser radar and the water surface may be expressed by formula (2):

$$H = ρ cos θ \qquad ( 2 )$$

Time t₁ when a vertical component of the laser light reaches the water surface is expressed by formula (3):

$${t}_{1} = 2 H / c \qquad ( 3 )$$

The delay time t₃ before sampling is expressed by formula (4):

$${t}_{3} = {t}_{1} + {t}_{2} \qquad ( 4 )$$

wherein, t₂ is time of a main wave signal.

In step 2, water surface and water bottom echo numerical values are converted into corresponding voltage amplitude values, then corresponding electric signals are calculated, and light energy is calculated through a photoelectric conversion relation.

A conversion relation between the echo numerical value and the analog voltage amplitude value may be expressed by formula (5):

$${V}_{Ana} = ( Data \times {V}_{p p} ) \div {2}^{a - 1} \qquad ( 5 )$$

wherein, V_{Ana} is the analog voltage amplitude value of the echo signal, Data is a value after AD conversion, Vₚₚ is a full-amplitude voltage of a chip, with a value of 1.7 V, a is a resolution, and the voltage amplitude value is calculated through formula (5). Moreover, the calculated voltage value is obtained after PMT amplification.

A multiplication factor M is equal to a product of a secondary electron emission yields δ of n multiplier electrodes. If all the δ of the n multiplier electrodes are the same, M=δ₁, so that an anode current I may be expressed by formula (6):

$$I = i \cdot {δ}_{i}^{n} \qquad ( 6 )$$

wherein, i is a photocurrent of a photocathode, and β is a current amplification factor of the photomultiplier tube, which may be expressed by formula (7):

$$β = I / i = {δ}_{i}^{n} \qquad ( 7 )$$

The M is related to an applied voltage, the M is 10⁵˜10⁸, a stability is 1%, and an acceleration voltage stability is less than 0.1%. If there is fluctuation, the multiplication factor will also fluctuate, so that the M has certain statistical fluctuation. Generally, a voltage between an anode and a cathode is 1000 V to 2500 V, and a potential difference between two adjacent multiplier electrodes is 50 V to 100 V. The more stable the applied voltage, the better the effect, which can reduce the statistical fluctuation, thus reducing a survey error. The water surface and water bottom electric signals before amplification may be calculated through formulas (5) and (7), which may be expressed by formula (8):

$${E}_{s} = \frac{{V}_{Ana}}{β} \qquad ( 8 )$$

wherein, Eₛ is the electric signal before amplification, V_{Ana} is the analog voltage amplitude value of the echo signal, and β is the current amplification factor.

After the electric signals are determined, the water surface and water bottom initial light energy may be obtained through the photoelectric conversion relation, and (a number of output electrons/a number of input photons) η(v) may be expressed by formula (9):

$$η ( v ) = ( 1 - R ) \frac{{P}_{v}}{k} \cdot ( \frac{1}{1 + 1 / kL} ) \cdot {P}_{s} \qquad ( 9 )$$

wherein, R is a reflection coefficient, k is a photon total absorption coefficient, Pᵥ is a probability of excitation to a vacuum level or above during light absorption, L is an average escape distance of excited electrons, Pₛ is a probability of emission of the electrons reaching the surface to vacuum, and v is a light vibration frequency.

In step 3, a water body attenuation coefficient is determined by water surface and water bottom light energy losses,
according to the following formula (10):

$$K = - \frac{1}{d} ln \frac{E ( d )}{E ( 0 )} \qquad ( 10 )$$

wherein, K is the water body attenuation coefficient, d is a depth, E(d) is light energy at the depth d, and E(0) is water surface light energy.

In step 4, a maximum water depth is determined by the solved water body attenuation coefficient, and then the sampling time is solved.

Water body absorption and scattering effects affect a maximum survey depth of an airborne bathymetric survey laser radar system, and the water body absorption and scattering effects are usually expressed by the water body attenuation coefficient K. The maximum survey depth and a water quality parameter are expressed with the water attenuation coefficient K by formula (11):

$${D}_{m} = \frac{ln ( {p}^{*} / {P}_{b} )}{2 K} \qquad ( 11 )$$

wherein, p* is a relevant parameter of the airborne bathymetric survey laser radar, P_{b} is a parameter of background light power, and K is the water body attenuation coefficient.

Finally, the sampling time may be expressed by formula (12)

$$T = 2 ( \frac{ρ}{c} + \frac{4 c {D}_{m}}{3} ) \qquad ( 12 )$$

wherein, ρ is the distance between the laser light and the water surface, c is a speed of light, and Dₘ is the maximum survey depth.

The above embodiments are only used to illustrate the present disclosure, and are not intended to limit the present disclosure. Those of ordinary skills in the related technical field can further make various changes and modifications without departing from the spirit and scope of the present disclosure. Therefore, all equivalent technical solutions also belong to the scope of the present disclosure, and the scope of protection of the present disclosure should be limited by the claims.

The technical contents not described in detail in the present disclosure are all well-known technologies.

What is claimed is:

1. A self-adaptive trigger acquisition method of an airborne bathymetric survey a laser radar, comprising the following steps:
step 1: calculating a distance between a laser light and a water surface through a main wave signal and a water surface echo signal, calculating a height between the laser radar and the water surface by a scanning angle of an elliptical scanning mode and a trigonometric function formula, calculating time when a vertical component of the laser light reaches the water surface by the height, and setting delay time before sampling to be a sum of time of the main wave signal and the time when the vertical component of the laser light reaches the water surface;
wherein the distance ρ between the laser light and the water surface is expressed by formula (1):
$$ρ = \frac{1}{2} \times t \times c \qquad ( 1 )$$
wherein t is time when the laser light reaches the water surface, and according to a water surface echo waveform, c is a propagation speed of light in air;
a reflecting mirror is evenly rotated, and a change of a scanning angle θ is similar to a cosine curve; when the reflecting mirror is rotated to satisfy that ϕ=0° or 180°, the scanning angle reaches a maximum degree of θₘₐₓ=15°; and when the reflecting mirror is rotated to satisfy that ϕ=90° or 270°, the scanning angle θ reaches a minimum degree of θₘᵢₙ=10° 35′29″,
the height H between the laser radar and the water surface is expressed by formula (2):
$$H = ρ cos θ \qquad ( 2 )$$
the time t₁ when the vertical component of the laser light reaches the water surface is expressed by formula (3):
$${t}_{1} = 2 H / c \qquad ( 3 )$$
the delay time t₃ before sampling is expressed by formula (4):
$${t}_{3} = {t}_{1} + {t}_{2} \qquad ( 4 )$$
wherein t₂ is the time of the main wave signal;
step 2: converting water surface and water bottom echo numerical values into corresponding analog a voltage amplitude values through a formula, obtaining corresponding an electric signal values by the voltage amplitude values and a PMT gains, and then obtaining water surface and water bottom light energy through a photoelectric conversion relation;
wherein a conversion relation between the echo numerical value and the analog voltage amplitude value is expressed by formula (5):
$${V}_{Ana} = ( Data \times {V}_{p p} ) \div {2}^{a - 1} \qquad ( 5 )$$
wherein V_{Ana} is the analog voltage amplitude value of the echo signal, Data is a value after AD conversion, Vₚₚ is a full-amplitude voltage of a chip, with a value of 1.7 V, a is a resolution, the voltage amplitude value is calculated through formula (5), and the calculated voltage value is obtained after PMT amplification;
step 3: determining water quality by comparing water surface and water bottom light energy losses, and then solving a water body attenuation coefficient, according to the following calculation formula (10):
$$K = - \frac{1}{d} ln \frac{E ( d )}{E ( 0 )} \qquad ( 10 )$$
wherein K is the water body attenuation coefficient, d is a depth, E(d) is light energy at the depth d, and E(0) is water surface light energy; and
step 4: determining a maximum water depth by the solved the water body attenuation coefficient, and then solving sampling time,
wherein the water body absorption and scattering effects affect a maximum survey depth of an airborne bathymetric survey laser radar system, the water body absorption and scattering effects are usually expressed by the water body attenuation coefficient K, and the maximum survey depth and a water quality parameter are expressed with the water attenuation coefficient K by formula (11):
$${D}_{m} = \frac{ln ( {p}^{*} / {P}_{b} )}{2 K} \qquad ( 11 )$$
wherein p* is a relevant parameter of the airborne bathymetric survey laser radar, P_{b} is a parameter of background light power, and K is the water body attenuation coefficient, and
finally, the sampling time is expressed by formula (12):
$$T = 2 ( \frac{ρ}{c} + \frac{4 c {D}_{m}}{3} ) \qquad ( 12 )$$
wherein C is a speed of light, and Dₘ is the maximum survey depth.
